(19) United States
(12) Patent Application Publication
(10) Pub. No.: US 2022/0153228 A1
(43) Pub. Date: May 19, 2022

(54) GETTING-OUT SUPPORT DEVICE

(71) Applicant: TOYOTA JIDOSHA KABUSHIKI KAISHA, Toyota-shi (JP)

(72) Inventors: Shinji NAGANO, Toyota-shi (JP); Masaho ISHIDA, Toyota-shi (JP); Noriyuki SAITOH, Nisshin-shi (JP); Koji TAKEUCHI, Toyota-shi (JP)

(73) Assignee: TOYOTA JIDOSHA KABUSHIKI KAISHA, Toyota-shi (JP)

(21) Appl. No.: 17/403,353

(22) Filed: Aug. 16, 2021

(30) Foreign Application Priority Data
Nov. 19, 2020 (JP) 2020-192332

(51) Int. Cl. B60R 25/20; E05F 15/73; B60R 25/01

(52) U.S. Cl. CPC B60R 25/20; E05F 15/73; B60R 25/01; E05Y 2900/531; E05F 2015/763; E05F 2015/765; E05Y 2400/52; E05F 2015/767

(57) ABSTRACT

A getting-out support device includes a door opening-closing operation tool that is operated by an occupant of a vehicle when the occupant opens or closes a door of the vehicle. In a case where a door opening prohibition condition that a moving body approaching the door is detected is satisfied, the getting-out support device maintains the door in the closed state even when the occupant performs the door opening operation to the door opening-closing operation tool, and thereafter, the getting-out support device continues to maintain the door in the closed state while an operation time during which the door opening operation is continuously being performed to the door opening-closing operation tool is shorter than a predetermined time, and finishes maintaining the door in the closed state when the operation time becomes equal to or longer than the predetermined time.

### CROSS-REFERENCE TO RELATED APPLICATION

This application claims priority to Japanese Patent Application No. 2020-192332 filed on Nov. 19, 2020, incorporated herein by reference in its entirety.

### BACKGROUND

### 1. Technical Field

The invention relates to a getting-out support device.

### 2. Description of Related Art

There is known a getting-out support device that secures the safety of an occupant of a vehicle. In the case where a moving body approaching the vehicle from the rear is detected, the getting-out support device does not unlock a door to avoid the door from being opened, even when the occupant tries to unlock the door. However, even when the moving body approaching the vehicle from the rear is detected, it is desirable that the door can be opened, in the case where it is necessary to open the door due to circumstances such as an emergency event, and in addition, it is desirable that the door can be opened, in the case where the occupant himself or herself makes the determination that it is safe to do so.

Hence, there is known a getting-out support device (see Japanese Unexamined Patent Application Publication No. 2017-122350, for example) that unlocks the door such that the door can be opened, in the case where the occupant operates a door locking operation tool a predetermined number of times or more for unlocking the door, even when the moving body approaching the vehicle from the rear is detected. With this conventional getting-out support device, the occupant can open the door, in the case where it is necessary to open the door due to circumstances such as an emergency event or in the case where the occupant himself or herself makes the determination that it is safe to do so.

### SUMMARY

As described above, in the case where the occupant operates the door locking operation tool the predetermined number of times or more, the conventional getting-out support device allows the door to be opened, even when the moving body approaching the vehicle from the rear is detected. However, in the case where the door is not opened by one operation to the door locking operation tool, there is a possibility that the occupant unconsciously operates the door locking operation tool many times. In this case, the door is opened even in the case where it is not necessary to open the door because circumstances such as an emergency event do not occur or even in the case where the occupant does not confirm the safety.

An object of the invention is to provide a getting-out support device that avoids the door from being opened by occupant's unconscious operation for opening the door when the door is prohibited from being opened for securing the safety for getting out.

A getting-out support device according to the invention includes: a door opening-closing operation tool that is operated by an occupant of a vehicle when the occupant opens or closes a door of the vehicle; and a controller that is capable of maintaining the door in a closed state even when the occupant performs a door opening operation to the door opening-closing operation tool for opening the door.

In a case where a door opening prohibition condition is satisfied, the controller maintains the door in the closed state even when the occupant performs the door opening operation to the door opening-closing operation tool, and thereafter, the controller continues to maintain the door in the closed state while an operation time is shorter than a predetermined time, and finishes maintaining the door in the closed state when the operation time becomes equal to or longer than the predetermined time, the door opening prohibition condition being a condition that a moving body approaching the door is detected, the operation time being a time during which the door opening operation is continuously being performed to the door opening-closing operation tool.

Generally, in the case where the door is not opened by one operation, there is a high possibility that the occupant unconsciously performs the door opening operation to the door opening-closing operation tool many times. However, there is a low possibility that the occupant unconsciously continuously performs the door opening operation to the door opening-closing operation tool for a certain time or longer, and the door opening operation continued for a certain time or longer is occupant's intentional operation. The getting-out support device according to the invention maintains the door in the closed state, such that the door cannot be opened, before the door opening operation has been continuously performed to the door opening-closing operation tool for the predetermined time, and finishes maintaining the door in the closed state, such that the door can be opened, when the door opening operation has been continuously performed to the door opening-closing operation tool for the predetermined time or longer. Therefore, the door can be opened only when the occupant intentionally performs the door opening operation to the door opening-closing operation tool. Accordingly, the door is avoided from being opened by occupant's unconscious door opening operation.

In the getting-out support device according to the invention, for example, the door opening-closing operation tool is a door locking operation tool that is operated by the occupant when the occupant locks or unlocks the door. In this case, for example, the door opening operation may be a door unlocking operation that is performed to the door locking operation tool by the occupant when the occupant unlocks the door. In this case, for example, the operation time may be a door unlocking operation time during which the door unlocking operation is continuously being performed to the door locking operation tool. In this case, in the case where the door opening prohibition condition is satisfied, the controller may maintain the door in a locked state even when the occupant performs the door unlocking operation to the door locking operation tool, and thereafter, the controller may maintain the door in the locked state while the door unlocking operation time is shorter than the predetermined time, and may unlock the door when the door unlocking operation time becomes equal to or longer than the predetermined time.

In this configuration, the getting-out support device maintains the door in the locked state, and thereby, maintains the door in the closed state, such that the door cannot be opened, before the door unlocking operation has been continuously performed to the door locking operation tool for the predetermined time. Further, the getting-out support device unlocks the door, and thereby, finishes maintaining the door in the closed state, such that the door can be opened, when the door unlocking operation has been continuously performed to the door locking operation tool for the predetermined time or longer. Therefore, the door can be opened only when the occupant intentionally performs the door unlocking operation to the door locking operation tool. Accordingly, the door is avoided from being opened by occupant's unconscious door unlocking operation.

Further, for example, the door opening-closing operation tool is a door dynamic-force opening-closing operation tool that is operated by the occupant when the occupant opens or closes the door by dynamic force. In this case, for example, the door opening operation is a door dynamic-force opening operation that is performed to the door dynamic-force opening-closing operation tool by the occupant when the occupant opens the door by dynamic force. In this case, the operation time is a door dynamic-force opening operation time during which the door dynamic-force opening operation is continuously being performed to the door dynamic-force opening-closing operation tool. In this case, in the case where the door opening prohibition condition is satisfied, the controller may maintain the door in the closed state even when the occupant performs the door dynamic-force opening operation to the door dynamic-force opening-closing operation tool, and thereafter, the controller may maintain the door in the closed state while the door dynamic-force opening operation time is shorter than the predetermined time, and may open the door by dynamic force when the door dynamic-force opening operation time becomes equal to or longer than the predetermined time.

In this configuration, the getting-out support device maintains the door in the closed state (that is, the door cannot be opened), before the door dynamic-force opening operation has been continuously performed to the door dynamic-force opening-closing operation tool for the predetermined time. The getting-out support device finishes maintaining the door in the closed state, and opens the door by dynamic force (that is, the door can be opened), when the door dynamic-force opening operation has been continuously performed to the door dynamic-force opening-closing operation tool for the predetermined time or longer. Therefore, the door can be opened only when the occupant intentionally performs the door dynamic-force opening operation to the door dynamic-force opening-closing operation tool. Accordingly, the door is avoided from being opened by occupant's unconscious door dynamic-force opening operation.

Constituent elements of the invention are not limited to embodiments of the invention that are described later with reference to the drawings. Other objects, other characteristics and ancillary advantages of the invention will be easily understood from descriptions about the embodiments of the invention.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a diagram showing a getting-out support device according to an embodiment of the invention;

FIG. 2 is a diagram showing a vehicle to which the getting-out support device according to the embodiment of the invention is applied;

FIG. 3 is a diagram showing a monitoring area;

FIG. 4A is a diagram showing a situation where a moving body approaches the vehicle from the rear;

FIG. 4B is a diagram showing a situation where a moving body approaches the vehicle from the rear;

FIG. 5 is a diagram showing a right rear monitoring area and a left rear monitoring area;

FIG. 6 is a diagram showing a right front monitoring area and a left front monitoring area;

FIG. 7 is a flowchart showing a routine that is executed by the getting-out support device according to the embodiment of the invention; and

FIG. 8 is a flowchart showing a routine that is executed by the getting-out support device according to the embodiment of the invention.

### DETAILED DESCRIPTION OF EMBODIMENTS

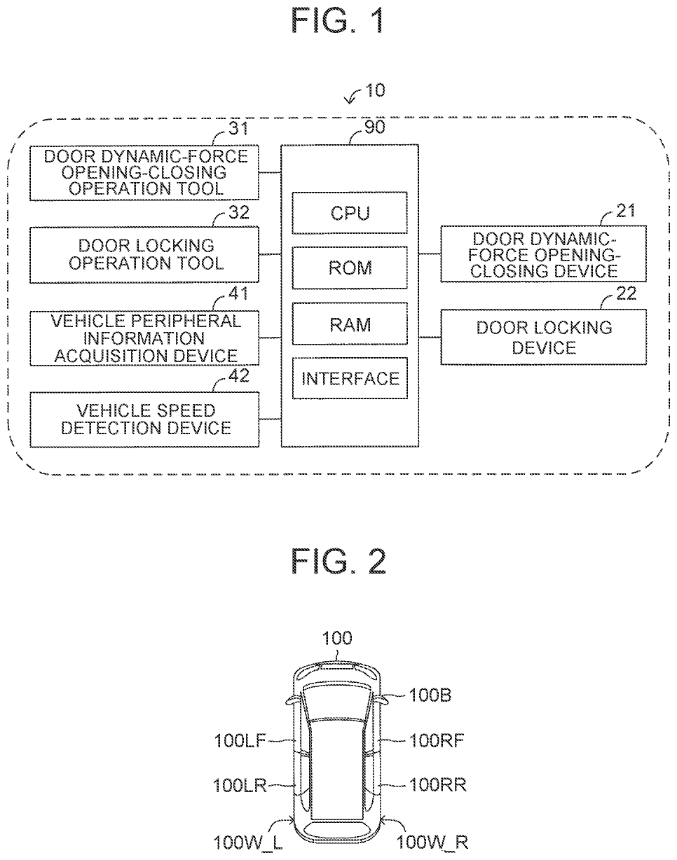

A getting-out support device according to an embodiment of the invention will be described below with reference to the drawings. FIG. 1 shows a getting-out support device 10 according to the embodiment of the invention. The getting-out support device 10 is mounted on a vehicle 100 (see FIG. 2).

ECU

As shown in FIG. 1, the getting-out support device 10 includes an ECU 90. The ECU is an abbreviation for an electronic control unit. The ECU 90 includes a microcomputer as a principal part. The microcomputer includes a CPU, a ROM, a RAM, a non-volatile memory, an interface, and others. The CPU realizes various functions by executing instructions, programs or routines stored in the ROM.

As shown in FIG. 2, in the embodiment, the vehicle 100 includes four doors 100D. The doors 100D include a door (right front door 100RF) provided in the right front of the vehicle 100, a door (right rear door 100RR) provided in the right rear of the vehicle 100, a door (left front door 100LF) provided in the left front of the vehicle 100, and a door (left rear door 100LR) provided in the left rear of the vehicle 100. Hereinafter, each of the right front door 100RF and the right rear door 100RR is also referred to as a “right door 100R”, and each of the left front door 100LF and the left rear door 100LR is also referred to as a “left door 100L”.

Each of the doors 100D is a swing type (that is, pivot type) door or a slide type (that is, sliding motion type) door. In the embodiment, the right front door 100RF and the left front door 100LF are swing type doors, and the right rear door 100RR and the left rear door 100LR are slide type doors.

The right front door 100RF and the left front door 100LF are attached to a vehicle body 100B of the vehicle 100 so as to be capable of swinging (that is, pivoting) about pivot axes that vertically extend at front portions of the right front door 100RF and the left front door 100LF. An occupant of the vehicle 100 can open the right front door 100RF in the closed state, by causing the right front door 100RF to pivot counterclockwise about the pivot axis of the right front door 100RF outward (that is, in a direction in which the right front door 100RF gets away from the vehicle body 100B), and conversely, can close the right front door 100RF in the opened state, by causing the right front door 100RF to pivot clockwise about the pivot axis of the right front door 100RF inward (that is, in a direction in which the right front door 100RF gets close to the vehicle body 100B). Similarly, the occupant of the vehicle 100 can open the left front door 100LF in the closed state, by causing the left front door 100LF to pivot clockwise about the pivot axis of the left front door 100LF outward (that is, in a direction in which the left front door 100LF gets away from the vehicle body 100B), and conversely, can close the left front door 100LF in the opened state, by causing the left front door 100LF to pivot counterclockwise about the pivot axis of the left front door 100LF inward (that is, in a direction in which the left front door 100LF gets close to the vehicle body 100B).

The right rear door 100RR and the left rear door 100LR are attached to the vehicle body 100B so as to be capable of sliding (moving while sliding) in a front-rear direction DX of the vehicle 100. As shown in FIG. 1, a door dynamic-force opening-closing device 21 and a door dynamic-force opening-closing operation tool 31 are mounted on the vehicle 100. The door dynamic-force opening-closing device 21 is a device (door opening-closing device) that opens or closes the right rear door 100RR and the left rear door 100LR by sliding the right rear door 100RR and the left rear door 100LR in the front-rear direction DX by dynamic force. Furthermore, the door dynamic-force opening-closing operation tool 31 is a device (door opening-closing operation tool) that is operated by the occupant of the vehicle 100 when the occupant opens or closes the right rear door 100RR and the left rear door 100LR, and for example, is a switch, a handle or the like that is attached to each of the right rear door 100RR and the left rear door 100LR.

The door dynamic-force opening-closing device 21 is electrically connected to the ECU 90. The ECU 90 controls the actuation of the door dynamic-force opening-closing device 21, and thereby, can open or close the right rear door 100RR and the left rear door 100LR by sliding the right rear door 100RR and the left rear door 100LR by dynamic force.

The door dynamic-force opening-closing operation tool 31 is also electrically connected to the ECU 90. When the door dynamic-force opening-closing operation tool 31 is operated in a state where the corresponding right rear door 100RR or the left rear door 100LR is closed, the door dynamic-force opening-closing operation tool 31 sends a predetermined signal to the ECU 90. In the case where the right rear door 100RR or the left rear door 100LR corresponding to the signal is not locked when the ECU 90 receives the signal and where a door opening prohibition condition described later is not satisfied or a temporal condition described later is satisfied after the ECU 90 receives the signal, the ECU 90 actuates the corresponding door dynamic-force opening-closing device 21, and slides and opens the corresponding right rear door 100RR or the left rear door 100LR by dynamic force. On the other hand, when the door dynamic-force opening-closing operation tool 31 is operated in a state where the corresponding right rear door 100RR or the left rear door 100LR is opened, the door dynamic-force opening-closing operation tool 31 sends a predetermined signal to the ECU 90. In the case where the ECU 90 receives the signal, the ECU 90 actuates the door dynamic-force opening-closing device 21 corresponding to the signal, and slides and closes the corresponding right rear door 100RR or the left rear door 100LR by dynamic force.

Door Locking Device and Others

Furthermore, a door locking device 22 and a door locking operation tool 32 are mounted on the vehicle 100.

Door Locking Device

The door locking device 22 is a device (door opening-closing device) for locking each door 100D. The door locking device 22 is electrically connected to the ECU 90. The ECU 90 controls the actuation of the door locking device 22, and thereby, locks or unlocks the door 100D.

Door Locking Operation Tool

The door locking operation tool 32 is a device (door opening-closing operation tool) that is operated by the occupant of the vehicle 100 when the occupant opens or closes the door 100D, and for example, is a button, a switch or the like that is attached to each door 100D. The door locking operation tool 32 is electrically connected to the ECU 90. When the door locking operation tool 32 is operated in a state where the corresponding door 100D is unlocked, the door locking operation tool 32 sends a predetermined signal to the ECU 90. In the case where the ECU 90 receives the signal, the ECU 90 actuates the corresponding door locking device 22, and locks the corresponding door 100D. On the other hand, when the door locking operation tool 32 is operated in a state where the corresponding door 100D is locked, the door locking operation tool 32 sends a predetermined signal to the ECU 90. In the case where the door opening prohibition condition described later is not satisfied when the ECU 90 receives the signal, or in the case where the temporal condition described later is satisfied after the ECU 90 receives the signal, the ECU 90 actuates the door locking device 22, and unlocks the corresponding door 100D.

Vehicle Peripheral Information Acquisition Device and Others

Furthermore, a vehicle peripheral information acquisition device 41 and a vehicle speed detection device 42 are mounted on the vehicle 100.

Vehicle Peripheral Information Acquisition Device

The vehicle peripheral information acquisition device 41 is a device that acquires information about the periphery of the vehicle 100, and, for example, includes a camera and at least one of sensors such as a radar sensor (millimeter-wave radar or the like), an ultrasonic sensor (clearance sonar) and a laser radar (LiDAR).

The vehicle peripheral information acquisition device 41 is electrically connected to the ECU 90. The vehicle peripheral information acquisition device 41 sends the acquired information (vehicle peripheral information) about the periphery of the vehicle 100, to the ECU 90. From the vehicle peripheral information, the ECU 90 detects a moving body 200 approaching the vehicle 100. In the embodiment, the moving body 200 is another vehicle, a motorcycle, a bicycle, a pedestrian or the like.

For example, in the case where the vehicle peripheral information acquisition device 41 includes a camera, the vehicle peripheral information is information of an image of the periphery of the vehicle 100 that is picked up by the camera. In this case, the ECU 90 detects the moving body 200 approaching the vehicle 100, from the information of the image.

In the case where the vehicle peripheral information acquisition device 41 includes a sensor, the vehicle peripheral information is information about a physical body, as exemplified by “a time after the sensor transmits an electromagnetic wave or acoustic wave and before the sensor receives a reflected wave of the electromagnetic wave or acoustic wave from the physical body” and “a direction in which the sensor receives the reflected wave of the electromagnetic wave or acoustic wave”. The ECU 90 detects the moving body 200 approaching the vehicle 100, from the information about the physical body.

Vehicle Speed Detection Device

The vehicle speed detection device 42 is a device that detects the vehicle speed of the vehicle 100, and includes a vehicle wheel speed sensor, for example. The vehicle speed detection device 42 is electrically connected to the ECU 90. The vehicle speed detection device 42 sends information about the detected vehicle speed of the vehicle 100, to the ECU 90. Based on the information, the ECU 90 acquires a vehicle speed V of the vehicle 100.

Outline of Actuation of Getting-Out Support Device

Next, an outline of the actuation of the getting-out support device 10 will be described. Suppose that the moving body 200 is approaching the door 100D that the occupant intends to open for getting out of the vehicle 100 in the stop state. In the case where the door 100D is a swing type door, there is a fear that the moving body 200 comes in contact with the door 100D when the occupant opens the door 100D. In the case where the door 100D is a slide type door, there is a fear that the moving body 200 comes in contact with the occupant when the occupant gets out of the vehicle 100 after opening the door 100D.

Hence, in the case where a door opening prohibition condition that the moving body 200 (target moving body 200T) approaching the locked door 100D (target door 100DT) is detected is satisfied when an operation (door opening operation; door unlocking operation) is performed to the door locking operation tool 32 corresponding to the door 100D, the getting-out support device 10 maintains the target door 100DT in the locked state without unlocking the target door 100DT, and thereby, maintains the target door 100DT in the closed state.

Thereafter, while a time (operation time; door unlocking operation time Tunlock) during which the door unlocking operation is continuously being performed to the door locking operation tool 32 is shorter than a predetermined time Tth, the getting-out support device 10 continues to maintain the target door 100DT in the locked state, and thereby, continues to maintain the target door 100DT in the closed state.

Then, when the door unlocking operation time Tunlock becomes equal to or longer than the predetermined time Tth, the getting-out support device 10 unlocks the target door 100DT, even when the door opening prohibition condition is satisfied, and thereby, finishes maintaining the target door 100DT in the closed state.

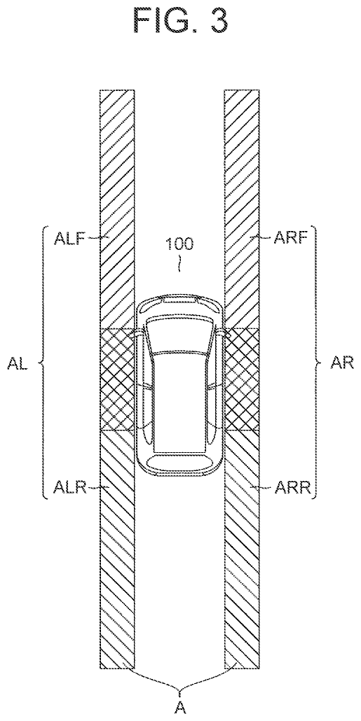

In the embodiment, as shown in FIG. 3, a monitoring area A is previously set, and in the case where the moving body 200 is traveling in the monitoring area A corresponding to the target door 100DT, the getting-out support device 10 detects the moving body 200 as the target moving body 200T.

The monitoring area A is an area that is set in a range including rearward regions on the right and left sides of the vehicle 100 and forward regions on the right and left sides of the vehicle 100, and includes a monitoring area (right monitoring area AR) on the right side of the vehicle 100 and a monitoring area (left monitoring area AL) on the left side of the vehicle 100. The right monitoring area AR includes a right rear monitoring area ARR and a right front monitoring area ARF, and the left monitoring area AL includes a left rear monitoring area ALR and a right front monitoring area ALF.

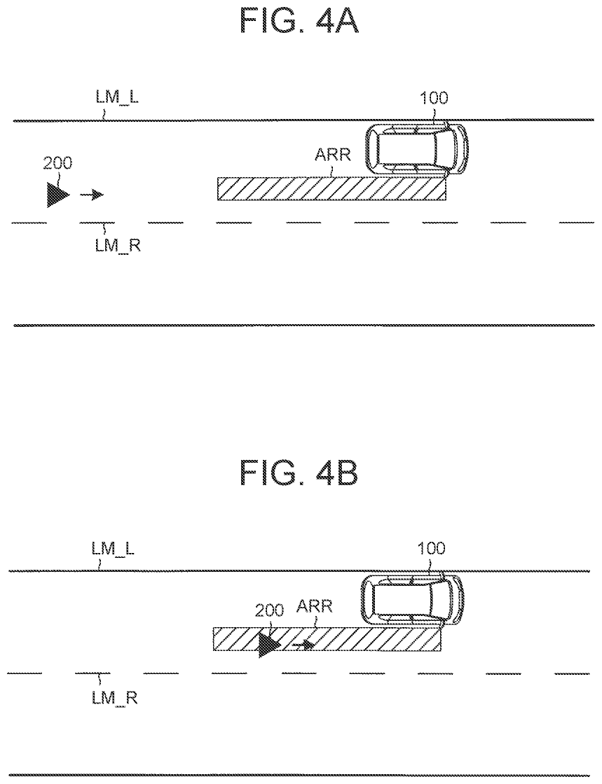

For example, in the case where the moving body 200 is approaching the vehicle 100 in the stop state from the rear as shown in FIG. 4A, the getting-out support device 10 detects the moving body 200.

Then, when the moving body 200 enters the right rear monitoring area ARR as shown in FIG. 4B, the getting-out support device 10 determines that the door opening prohibition condition is satisfied for the right door 100R. The getting-out support device 10 determines that the door opening prohibition condition is satisfied, while the moving body 200 (target moving body 200T) is moving in the right rear monitoring area ARR.

In the case where the door unlocking operation for the right door 100R is performed to the door locking operation tool 32 corresponding to the right door 100R (target door 100DT) when the door opening prohibition condition is satisfied, the getting-out support device 10 maintains the right door 100R in the locked state, without unlocking the right door 100R.

Then, the getting-out support device 10 continues to maintain the right door 100R in the locked state, while the door unlocking operation time Tunlock is shorter than the predetermined time Tth.

Then, when the door unlocking operation time Tunlock becomes equal to or longer than the predetermined time Tth, the getting-out support device 10 unlocks the right door 100R, even when the door opening prohibition condition is satisfied.

Furthermore, in the case where a door opening prohibition condition that the moving body 200 (target moving body 200T) approaching the right rear door 100RR or the left rear door 100LR (target door 100DT) that is unlocked but is closed is detected is satisfied when an operation (door opening operation; door dynamic-force opening operation) is performed to the door dynamic-force opening-closing device 21 corresponding to the right rear door 100RR or the left rear door 100LR, the getting-out support device 10 does not actuate the door dynamic-force opening-closing device 21 corresponding to the target door 100DT, and thereby, maintains the target door 100DT in the closed state.

Thereafter, while a time (operation time; door dynamic-force opening operation time Topen) during which the door dynamic-force opening operation is continuously being performed to the door dynamic-force opening-closing operation tool 31 is shorter than the predetermined threshold time Tth, the getting-out support device 10 does not actuate the door dynamic-force opening-closing device 21 corresponding to the target door 100DT, and thereby, continues to maintain the target door 100DT in the closed state.

Then, when the door dynamic-force opening operation time Topen becomes equal to or longer than the predetermined time Tth, the getting-out support device 10 actuates the door dynamic-force opening-closing device 21 corresponding to the target door 100DT, and slides and opens the target door 100DT by dynamic force, even when the door opening prohibition condition is satisfied. Thereby, the getting-out support device 10 finishes maintaining the target door 100DT in the closed state.

In the embodiment, the “predetermined time Tth to be compared with the door unlocking operation time Tunlock” and the “predetermined time Tth to be compared with the door dynamic-force opening operation time Topen” are set to the same time mutually, but may be set to different times.

In the case where the target moving body 200T disappears before the door unlocking operation time Tunlock or the door dynamic-force opening operation time Topen becomes equal to or longer than the predetermined time Tth, the getting-out support device 10 unlocks the target door 100DT, or opens the target door 100DT by dynamic force.

Effect

Generally, in the case where the door 100D is not opened by one operation, there is a high possibility that the occupant unconsciously performs the door unlocking operation or door dynamic-force opening operation to the door locking operation tool 32 or the door dynamic-force opening-closing operation tool 31 many times. However, there is a low possibility that the occupant unconsciously continuously performs the door unlocking operation or door dynamic-force opening operation to the door locking operation tool 32 or the door dynamic-force opening-closing operation tool 31 for a certain time or longer, and the door unlocking operation or door dynamic-force opening operation continued for a certain time or longer is occupant's intentional operation.

Before the door unlocking operation or door dynamic-force opening operation has been continuously performed to the door locking operation tool 32 or the door dynamic-force opening-closing operation tool 31 for the predetermined time Tth, the getting-out support device 10 does not unlock the target door 100DT or does not open the target door 100DT by dynamic force, and thereby maintains the target door 100DT in the closed state. In the case where the door unlocking operation or door dynamic-force opening operation has been continuously performed to the door locking operation tool 32 or the door dynamic-force opening-closing operation tool 31 for the predetermined time Tth or longer, the getting-out support device 10 unlocks the target door 100DT or opens the target door 100DT by dynamic force, and thereby, finishes maintaining the target door 100DT in the closed state. Therefore, the target door 100DT can be opened only when the occupant intentionally performs the door unlocking operation or door dynamic-force opening operation to the door locking operation tool 32 or the door dynamic-force opening-closing operation tool 31. Accordingly, the target door 100DT is avoided from being opened by the door unlocking operation or door dynamic-force opening operation that is unconsciously performed by the occupant.

Right Rear Monitoring Area

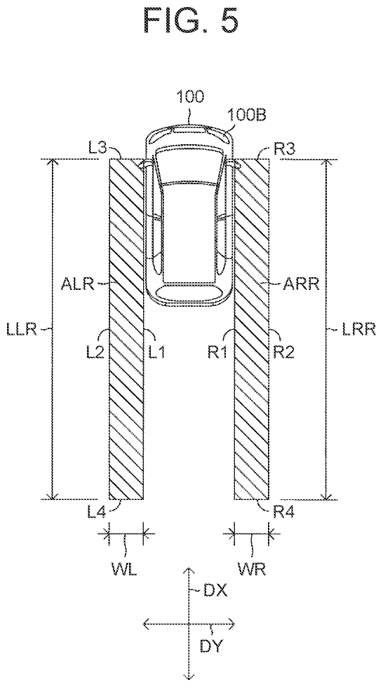

As shown in FIG. 5, the right rear monitoring area ARR is an area that is determined by a first right line R1, a second right line R2, a third right line R3 and a fourth right line R4. The first right line R1 is a line that extends along a right wall surface 100W R of the vehicle 100 in the front-rear direction DX of the vehicle 100. The second right line R2 is a line that has a predetermined distance (predetermined right-side width WR) on the right side of the first right line R1 and that extends in the front-rear direction DX of the vehicle 100 parallel to the first right line R1. The third right line R3 is a line that passes through a front end portion of the right front door 100RF and that extends in a lateral direction DY of the vehicle 100. The fourth right line R4 is a line that has a predetermined distance (predetermined right rear length LRR) on the rear side of the third right line R3 and that extends in the lateral direction DY of the vehicle 100 parallel to the third right line R3. In the embodiment, the predetermined right-side width WR is set to such a length that the moving body 200 does not come in contact with the right door 100R when the pivot angle of the right door 100R is the maximum angle.

Left Rear Monitoring Area

As shown in FIG. 5, the left rear monitoring area ALR is an area that is determined by a first left line L1, a second left line L2, a third left line L3 and a fourth left line L4. The first left line L1 is a line that extends along a left wall surface 100W L of the vehicle 100 in the front-rear direction DX of the vehicle 100. The second left line L2 is a line that has a predetermined distance (predetermined left-side width WL) on the left side of the first left line L1 and that extends in the front-rear direction DX of the vehicle 100 parallel to the first left line L1. The third left line L3 is a line that passes through a front end portion of the left front door 100LF and that extends in the lateral direction DY of the vehicle 100. The fourth left line L4 is a line that has a predetermined distance (predetermined left rear length LLR) on the rear side of the third left line L3 and that extends in the lateral direction DY of the vehicle 100 parallel to the third left line L3. In the embodiment, the predetermined left-side width WL is set to such a length that the moving body 200 does not come in contact with the left door 100L when the pivot angle of the left door 100L is the maximum angle. In the embodiment, the predetermined right-side width WR and the predetermined left-side width WL are equal to each other, and the predetermined right rear length LRR and the predetermined left rear length LLR are equal to each other.

Right Front Monitoring Area

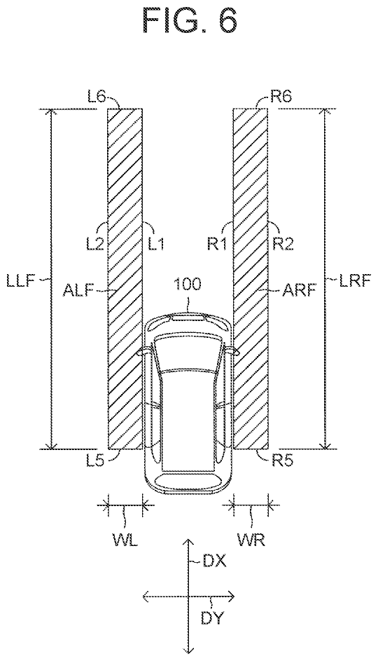

As shown in FIG. 6, the right front monitoring area ARF is determined by the first right line R1, the second right line R2, a fifth right line R5 and a sixth right line R6. The fifth right line R5 is a line that passes through a rear end portion of the right rear door 100RR and that extends in the lateral direction DY of the vehicle 100. The sixth right line R6 is a line that has a predetermined distance (predetermined right front length LRF) on the front side of the fifth right line R5 and that extends in the lateral direction DY of the vehicle 100 parallel to the fifth right line R5.

Left Front Monitoring Area

As shown in FIG. 6, the left front monitoring area ALF is determined by the first left line L1, the second left line L2, a fifth left lie L5 and a sixth left line L6. The fifth left line L5 is a line that passes through a rear end portion of the left rear door 100LR and that extends in the lateral direction DY of the vehicle 100. The sixth left line L6 is a line that has a predetermined distance (predetermined left front length LLF) on the front side of the fifth left line L5 and that extends in the lateral direction DY of the vehicle 100 parallel to the fifth left line L5. The predetermined right front length LRF and the predetermined left front length LLF may be different from each other, but are equal to each other in the embodiment.

Specific Behavior of Getting-Out Support Device

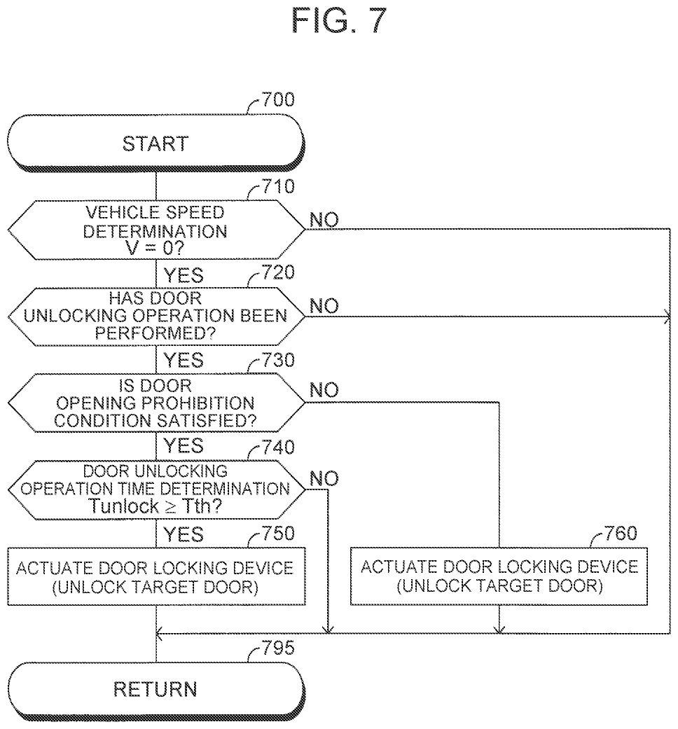

Next, a specific behavior of the getting-out support device 10 will be described. The CPU of the ECU 90 of the getting-out support device 10 executes a routine shown in FIG. 7 whenever a predetermined computation time lapses. Accordingly, the CPU starts the process from step 700 in FIG. 7 at a predetermined timing, advances the process to step 710, and determines whether the vehicle speed V is zero.

In the case where the CPU makes the determination of “Yes” in step 710, the CPU advances the process to step 720, and determines whether the door unlocking operation has been performed to the door locking operation tool 32.

In the case where the CPU makes the determination of “Yes” in step 720, the CPU advances the process to step 730, and determines whether the door opening prohibition condition is satisfied for the door 100D (target door 100DT) corresponding to the door locking operation tool 32 to which the door unlocking operation has been performed.

In the case where the CPU makes the determination of “Yes” in step 730, the CPU advances the process to step 740, and determines whether the door unlocking operation time Tunlock is equal to or longer than the predetermined time Tth.

In the case where the CPU makes the determination of “Yes” in step 740, the CPU advances the process to step 750, and actuates the door locking device 22 corresponding to the target door 100DT, to unlock the target door 100DT. Next, the CPU advances the process to step 795, and ends the routine once.

On the other hand, in the case where the CPU makes the determination of “No” in step 740, the CPU directly advances the process to step 795, and ends the routine once. In this case, the target door 100DT is maintained in the locked state.

Further, in the case where the CPU makes the determination of “No” in step 730, the CPU advances the process to step 760, and actuates the door locking device 22 corresponding to the target door 100DT, to unlock the target door 100DT. Next, the CPU advances the process to step 795, and ends the routine once.

Further, in the case where the CPU makes the determination of “No” in step 710 and step 720, the CPU directly advances the process to step 795, and ends the routine once.

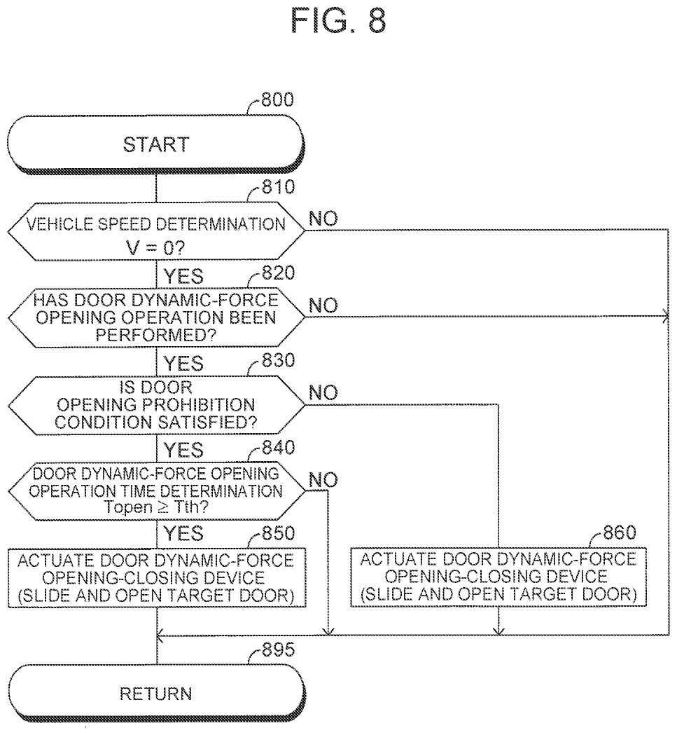

Furthermore, the CPU executes a routine shown in FIG. 8 whenever a predetermined computation time lapses. Accordingly, the CPU starts the process from step 800 in FIG. 8 at a predetermined timing, advances the process in step 810, and determines whether the vehicle speed V is zero.

In the case where the CPU makes the determination of “Yes” in step 810, the CPU advances the process to step 820, and determines whether the door dynamic-force opening operation has been performed to the door dynamic-force opening-closing operation tool 31.

In the case where the CPU makes the determination of “Yes” in step 820, the CPU advances the process to step 830, and determines whether the door opening prohibition condition is satisfied for the door 100D (target door 100DT) corresponding to the door dynamic-force opening-closing operation tool 31 to which the door dynamic-force opening operation has been performed.

In the case where the CPU makes the determination of “Yes” in step 830, the CPU advances the process to step 840, and determines whether the door dynamic-force opening operation time Topen is equal to or longer than the predetermined time Tth.

In the case where the CPU makes the determination of “Yes” in step 840, the CPU advances the process to step 850, and actuates the door dynamic-force opening-closing device 21 corresponding to the target door 100DT, to slide and open the target door 100DT by dynamic force. Next, the CPU advances the process to step 895, and ends the routine once.

On the other hand, in the case where the CPU makes the determination of “No” in step 840, the CPU directly advances the process to step 895, and ends the routine once. In this case, the target door 100DT is maintained in the closed state.

Further, in the case where the CPU makes the determination of “No” in step 830, the CPU advances the process to step 860, and actuates the door dynamic-force opening-closing device 21 corresponding to the target door 100DT, to slide and open the target door 100DT by dynamic force. Next, the CPU advances the process to step 895, and ends the routine once.

Further, in the case where the CPU makes the determination of “No” in step 810 and step 820, the CPU directly advances the process to step 895, and ends the routine once.

The above-described behavior is the specific behavior of the getting-out support device 10.

The invention is not limited to the above embodiment, and various modifications can be employed within the scope of the invention.

What is claimed is:

1. A getting-out support device comprising:
a door opening-closing operation tool that is operated by an occupant of a vehicle when the occupant opens or closes a door of the vehicle; and
a controller that is capable of maintaining the door in a closed state even when the occupant performs a door opening operation to the door opening-closing operation tool for opening the door, wherein
in a case where a door opening prohibition condition is satisfied, the controller maintains the door in the closed state even when the occupant performs the door opening operation to the door opening-closing operation tool, and thereafter, the controller continues to maintain the door in the closed state while an operation time is shorter than a predetermined time, and finishes maintaining the door in the closed state when the operation time becomes equal to or longer than the predetermined time, the door opening prohibition condition being a condition that a moving body approaching the door is detected, the operation time being a time during which the door opening operation is continuously being performed to the door opening-closing operation tool.

2. The getting-out support device according to claim 1, wherein:
the door opening-closing operation tool is a door locking operation tool that is operated by the occupant when the occupant locks or unlocks the door;
the door opening operation is a door unlocking operation that is performed to the door locking operation tool by the occupant when the occupant unlocks the door;
the operation time is a door unlocking operation time during which the door unlocking operation is continuously being performed to the door locking operation tool; and
in the case where the door opening prohibition condition is satisfied, the controller maintains the door in a locked state even when the occupant performs the door unlocking operation to the door locking operation tool, and thereafter, the controller maintains the door in the locked state while the door unlocking operation time is shorter than the predetermined time, and unlocks the door when the door unlocking operation time becomes equal to or longer than the predetermined time.

3. The getting-out support device according to claim 1, wherein:
the door opening-closing operation tool is a door dynamic-force opening-closing operation tool that is operated by the occupant when the occupant opens or closes the door by dynamic force;
the door opening operation is a door dynamic-force opening operation that is performed to the door dynamic-force opening-closing operation tool by the occupant when the occupant opens the door by dynamic force;
the operation time is a door dynamic-force opening operation time during which the door dynamic-force opening operation is continuously being performed to the door dynamic-force opening-closing operation tool; and
in the case where the door opening prohibition condition is satisfied, the controller maintains the door in the closed state even when the occupant performs the door dynamic-force opening operation to the door dynamic-force opening-closing operation tool, and thereafter, the controller maintains the door in the closed state while the door dynamic-force opening operation time is shorter than the predetermined time, and opens the door by dynamic force when the door dynamic-force opening operation time becomes equal to or longer than the predetermined time.
